(19) United States
(12) Patent Application Publication
(10) Pub. No.: US 2015/0302061 A1
(43) Pub. Date: Oct. 22, 2015

(54) SYSTEM AND METHOD FOR EFFICIENT DATA ENTRY IN A CUSTOMER RELATIONSHIP MANAGEMENT SYSTEM

(71) Applicant: salesforce.com, inc., San Francisco, CA (US)

(72) Inventors: Ivan Bogdanov, San Francisco, CA (US); Ken Wakamatsu, San Francisco, CA (US)

(73) Assignee: SALESFORCE.COM, INC., San Francisco, CA (US)

(21) Appl. No.: 14/624,753

(22) Filed: Feb. 18, 2015

Related U.S. Application Data
(60) Provisional application No. 61/981,727, filed on Apr. 18, 2014.

(51) Int. Cl. G06F 17/30

(52) U.S. Cl. CPC G06F 17/30528; G06F 17/30371

(57) ABSTRACT

A customer relationship management system and a method for controlling the same are provided. A method for linking data by a database system, for example, may include, but is not limited to receiving data entered in a data field in an application on a computer-implemented system, comparing the data entered in the data field with data entries stored in the database system, creating at least one suggestion for linking the data entered in the data field with one of the data entries stored in the database system based upon the comparison, transmitting the at least one suggestion to the computer-implemented system, and linking the data entered in the data field with a respective data entry associated with one of the at least one suggestions when the processor receives confirmation of an association of the data entered with the suggestion.

### CROSS-REFERENCE TO RELATED APPLICATION(S)

This application claims the benefit of U.S. provisional patent application Ser. No. 61/981,727, filed Apr. 18, 2014, the entire content of which is incorporated by reference herein.

### TECHNICAL FIELD

The present disclosure generally relates to database systems, and more particularly relates to linking notes with data in a database system.

### BACKGROUND

Salesmen are often required to track their sales calls, meetings and other general sales activity. However, tracking sales activity can be a time consuming process. This is especially true on mobile devices which may have input systems which are difficult to use.

### BRIEF DESCRIPTION OF THE DRAWINGS

The detailed description will hereinafter be described in conjunction with the following drawing figures, wherein like numerals denote like elements, and wherein:

FIG. 1 illustrates an exemplary customer relationship management system, in accordance with an embodiment;

FIG. 2 illustrates an exemplary note taking application running on a computer implemented device, in accordance with an embodiment;

FIG. 3 is a flow diagram illustrating an exemplary method of operating a CRM system, in accordance with an embodiment; and

FIGS. 4-7 illustrate an exemplary note taking application running on a computer implemented device, in accordance with an embodiment.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, or the following detailed description.

In accordance with one embodiment, a customer relationship management system is provided. As discussed in further detail below, the customer relationship management system includes a database system and at least one computer implemented device. The database system and the at least one computer implemented device are configured to implement a note taking application which provides an improved method for taking notes (e.g., meeting notes, sales notes or the like) and tracking notes for users of the customer relationship management system. As discussed in further detail below, the system analyzes user input into the note taking application to accurately determine who and what the user is talking about. The system then provides accurate suggested input to the user to speed up the note taking process.

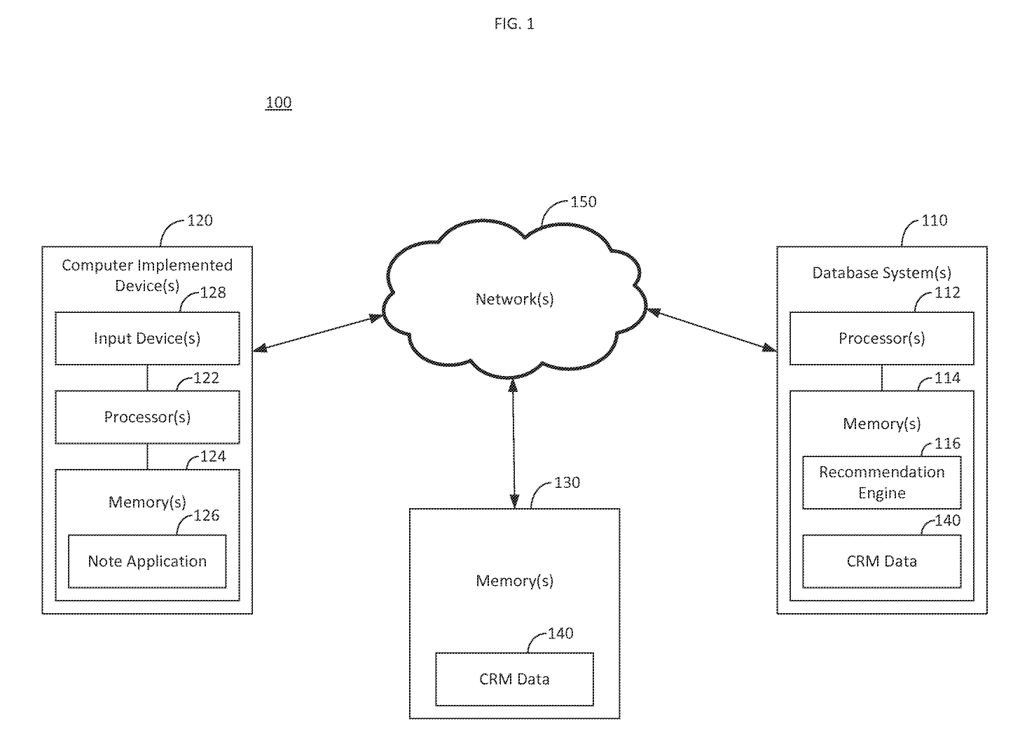

FIG. 1 illustrates an exemplary customer relationship management system 100, in accordance with an embodiment. The customer relationship management system 100, hereinafter referred to as CRM system 100, includes one or more database systems 110. Each database system 110 includes one or more processors 112. The processor(s) 112 may be, for example, a central processing unit (CPU), a graphical processing unit (GPU), a field programmable gate array (FPGA), a microcontroller, an application specific integrated circuit (ASIC), or any other logic device or combination thereof. As discussed in further detail below, the processor(s) 112 of the database system 110 execute non-transitory computer-readable instructions for implementing components of the CRM system 100.

The database system 110 further includes at least one memory 114. The memory 114 may be any combination of volatile and non-volatile memory. The memory 114 further includes non-transitory computer readable instructions 116 for operating a recommendation engine, as discussed in further detail below.

In one embodiment, for example, the database system 110 may store information from one or more tenants (e.g., businesses, other organizations or users) into tables of a common database image to form an on-demand database service (ODDS), which can be implemented in many ways, including, but not limited to, a multi-tenant database system (MTDS). A database image can include one or more database objects. In other implementations, the database system 110 can be implemented as a relational database management system (RDBMSs), an object oriented database management system (OODBMSs), a distributed file system (DFS), a no-schema database, or any other style of data storing system.

The CRM system 100 further includes one or more computer implemented devices 120. The computer implemented devices 120 can include, but are not limited to, cellular phones, tablets, laptops, personal digital assistants, vehicles (e.g., a touchscreen interface or other display controlled via an external interface in the vehicle), wearable devices (e.g., smart watches, smarty glasses or the like), desktop computers, kiosks, or the like. Each computer implemented device 120 includes at least one processor 122. The processor(s) 122 may be, for example, a central processing unit (CPU), a graphical processing unit (GPU), a field programmable gate array (FPGA), a microcontroller, an application specific integrated circuit (ASIC), or any other logic device or combination thereof. As discussed in further detail below, the processor(s) 122 of the computer implemented device(s) 120 execute non-transitory computer-readable instructions for implementing components of the CRM system 100.

Each computer implemented device 120 further includes at least one memory 124. The memory 124 may be any combination of volatile and non-volatile memory. The memory 124 further includes non-transitory computer readable instructions 126 for operating a note application, as discussed in further detail below.

While the database system(s) 110 and computer implemented device(s) 120 are illustrated as having local memory, the database system(s) 110 and computer implemented device(s) 120 may also be configured to communicate with one or more remote memory units 130, such as a cloud storage system or any other memory system which can be accessed through a communication system (not illustrated) and protocol including, but not limited to a wired network, a wireless network (e.g., WiFi, Bluetooth, Zigbee or the like), a cellular network, a satellite network or any other communication network or combination thereof. Further, while the instructions for operating the note application and the recommendation engine are illustrated as being stored in the respective local memories, the instructions for operating the note application and the recommendation engine could also be save in one or more of the remote memory units 130.

The computer implemented device(s) further include at least one input devices 128. The input device(s) 128 can include, but are not limited to, a mouse, a keyboard, a touchpad, a microphone, a camera, a touchscreen, a wheel, a scanner, or the like, or any combination thereof. The input device(s) 128 receive user input to enter notes in the note taking application as wells as to interact with the note taking application, as discussed in further detail below.

The CRM system 100 further includes CRM data 140. The CRM data may be stored at one or more of the database systems 110 at one or more of the remote memory units 130 or a combination thereof. Furthermore, some of the CRM data 140 could be stored on one or more of the computer implemented devices 120, as discussed in further detail below.

The CRM data 140 may include, but is not limited to, data identifying various entities (persons and organizations) such as contacts, accounts, opportunities, and/or leads and further provides business information related to the respective entities. Examples of business information can include names, addresses, job titles, number of employees, industry types, territories, market segments, contact information, employer information, stock rate, etc. In one embodiment, for example, the CRM data 140 can include web or database profiles of the users and organizations as a system of interlinked hypertext documents that can be accessed via the network 150 (e.g., the Internet). In one embodiment, for example, the CRM data 140 can also include standard profile information about persons and organizations. This standard profile information can be extracted from company websites, business registration sources such as Jigsaw, Hoovers, or D&B, business intelligence sources, and/or social networking websites like Yelp, Yellow Pages, or the like.

A “lead” refers to an entity (person or organization) that has expressed interest in a product or service of a seller or service provider. Conversely, a lead can be an entity that may not have expressed interest but appears to have a profile similar to that of seller's or service provider's target customer. In one implementation, leads can be stored based on industry type, market segment, number of employees, customer segment, employee size, product line, service type, stock rate, location, or territory. In another implementation, the CRM data 140 can include business-to-business data of individuals belonging to a lead, referred to as “contacts,” along with some supplemental information. This supplemental information can be names, addresses, job titles, usernames, contact information, employer name, or the like.

An “opportunity” is an entity (person or organization) that has taken an affirmative action to show the intent and ability to purchase a given type of product or service. A qualification process can be used to identify opportunities. The qualification process can include determining whether an opportunity has a need for a product or service, that the opportunity sees value in an offering, that the opportunity has the financial resources for a deal, that there is access to a decision-maker, etc. Opportunities can be classified based on industry type, number of employees, market segment, customer segment, employee size, product line, service type, stock rate, location, or territory. In one implementation, the CRM data 140 can include business-to-business data of individuals belonging to an opportunity, referred to as “contacts,” along with some supplemental information. This supplemental information can be names, addresses, job titles, usernames, contact information, employer name, or the like.

An “account” is an entity (person or organization) that has contractually committed to purchase a given type of product or service. Accounts can be classified based on revenue generated, delivery, payment, industry type, number of employees, market segment, customer segment, employee size, product line, service type, stock rate, location, or territory. In one embodiment, for example, the CRM data 140 can include business-to-business data of individuals belonging to an opportunity, referred to as “contacts,” along with some supplemental information. This supplemental information can be names, addresses, job titles, usernames, contact information, employer name, or the like.

A “contact” refers to a person in an organization with whom a sales representative can communicate in pursuit of a lead or opportunity. It can also refer to a person working for or representing an existing account. In one implementation, contacts can be stratified based at least on geographic territories, job functions, skills, expertise, age, gender, or location proximities.

The CRM data 140 may also include social media content like social media sources, social accounts, social personas, social profiles, social handles, etc. In some instances, social media content can add social context to the business-to-business contacts held in the CRM data 140. Conversely, business-to-business contacts can add business context to the social personas or profiles.

As discussed in further detail below, the database system 110 utilizes the CRM data 140 to suggest data entries to the user of the note taking application. In one embodiment, for example, the database system 110 may also update the CRM data 140 based upon the content of the note that the user is entering into the note taking application.

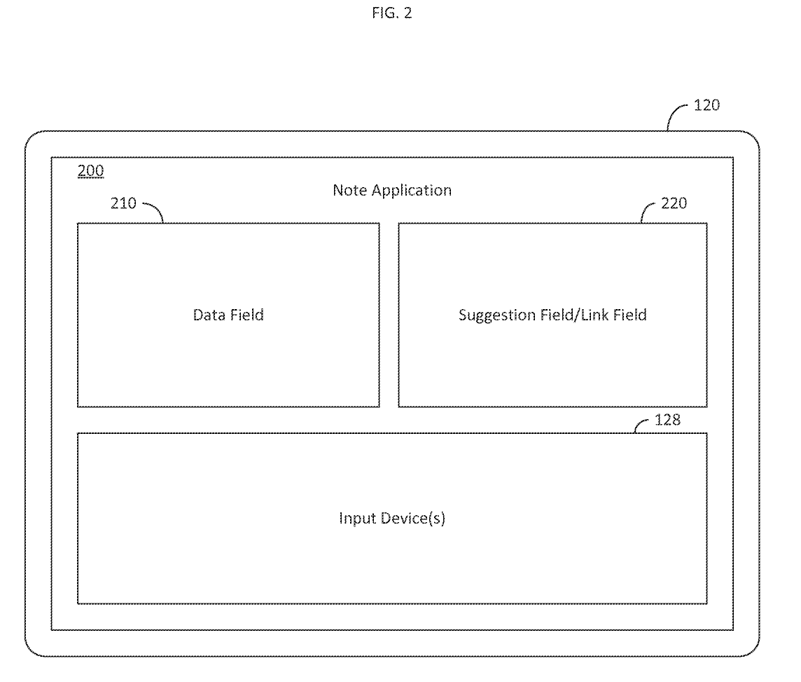

FIG. 2 illustrates an exemplary note taking application 200 running on a computer implemented device 120, in accordance with an embodiment. The note taking application 200 may be any application capable of connecting to the CRM data 140 through the network 150. In one embodiment, for example, the note taking application 200 can be integrated into a platform, such as Salesforce1. However, in other embodiments, the note taking application 200 may be a standalone application or a plug-in or extension for another application, such as a word processor, a web browser, a messaging application (e.g., text messaging, voice messaging, or the like), a social media application, office productivity applications (e.g., Evernote, Microsoft OneNote), or the like. The note taking application 200 can take one of a number of forms, including user interfaces, dashboard interfaces, engagement consoles, and other interfaces, such as mobile interfaces, tablet interfaces, summary interfaces, or wearable interfaces. In some implementations, it can be hosted on a web-based or cloud-based privacy management application running on a computing device such as a personal computer, laptop computer, mobile device, and/or any other hand-held computing device. It can also be hosted on a non-social local application running in an on-premise environment. In one implementation, the note taking application 200 can be accessed from a browser running on a computing device. The browser can be Chrome, Internet Explorer, Firefox, Safari, and the like. In other implementations, the note taking application 200 can run as an engagement console on a computer desktop application.

The note taking application 200 includes at least one data field 210. A user of the application can enter notes on, for example, a meeting in the data field 210. As discussed in further detail below, the note taking application 200 suggests data for the notes and links the notes entered by the user with the CRM data 140.

A user can enter the notes via one or more input devices 128. As discussed above, the input devices can include, but are not limited to, a keyboard, a mouse, a touchpad, voice recognition, a scanner (e.g., to scan and analyze hand written notes) or the like. In the embodiment illustrated in FIG. 2, the computer implemented device 120 is arranged as an exemplary tablet device having a keyboard type input device 128 displayed below the data field 210. However, one of ordinary skill in the art would recognize that the size, position, type and orientation of any interfaces of the note taking application 200 can vary.

The note taking application 200 further includes a suggestion/link field 220. As discussed in further detail below, the note taking application may display suggestions for the user entering the note in the suggestion/link field 220. The suggestions can aid the user in entering the note more quickly by suggesting data from the CRM data 140 which the user may be trying to enter. The suggestions can include, but are not limited to, a name (e.g., a person, a company name, a product name, or the like), an address, a telephone number, an email address, a job title, business information or the like. The business information may be, for example, industry type, territories, market segments, contract information, campaign, invoice, order, product, or the like. Furthermore, while the data field 210 and the suggestion/link field 220 are illustrated as separate interfaces in the figures, the data field 210 and the suggestion/link field 220 can be integrated into a single interface, or into three separate interfaces.

In one embodiment, for example, the note taking application 200 may initiate a suggestion based upon input from a user proximate to the one or more letters or words. The user can interface with the note taking application 200 by, for example, by clicking (right click, left click, shift-click, control-click, or the like) on one or more letters or words in a note. In another embodiment, for example, the user can initiate a suggestion by highlighting one or more letters or words in a note. In yet other embodiments, the suggestion could be initiated by mousing over a word, via a voice command, via a dedicated button (e.g., a physical button on the computer implemented device 120 or a soft button displayed on a display of the computer implemented device 120), by scanning a business card, or the like.

In yet another embodiment, for example, the note taking application 200 may automatically initiate a suggestion. In this embodiment, for example, the note taking application 200 may initiate a suggestion after the user has typed at least one character in the data field 210. In one embodiment, for example, each new character typed by the user may initiate a new suggestion. In other embodiments, for example, suggestions may be initiated at other rates, for example, after a space or other punctuation is entered by the user.

The note taking application 200 may utilize any one or any combination of the methods for initiating the suggestion.

As discussed in further detail below, if a user accepts one of the suggestions, the note taking application 200 links the note with the CRM data 140. The linking of the note with the CRM data 140 allows the user to quickly enter the note while also allowing the database system 110 to accurately track the notes.

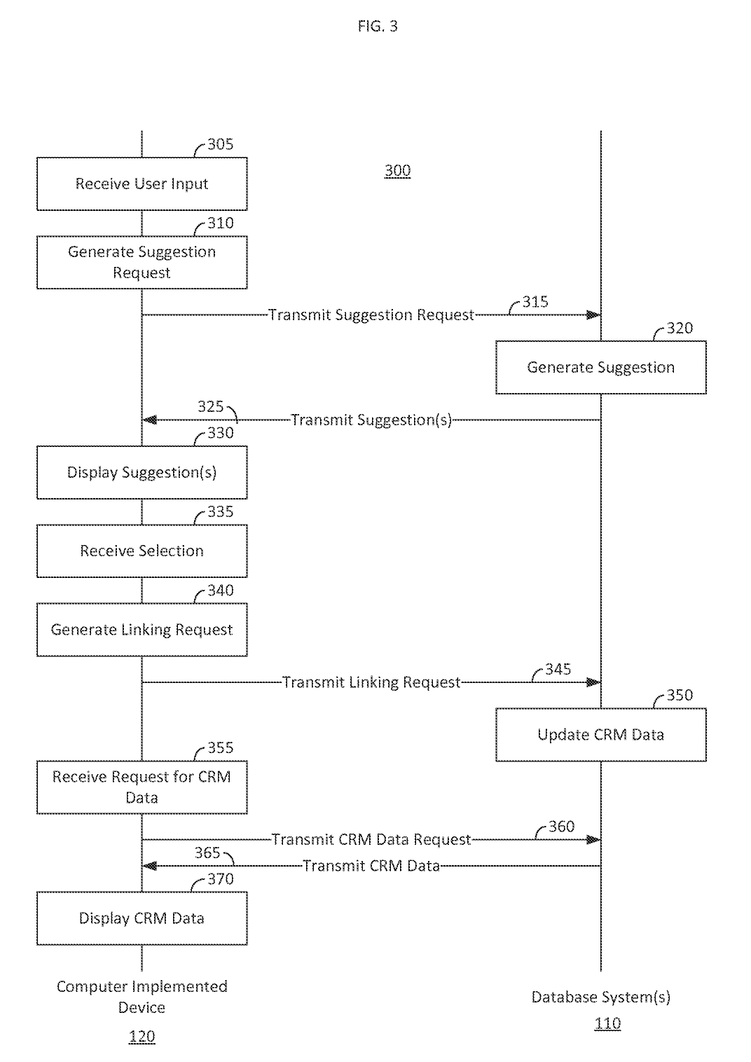

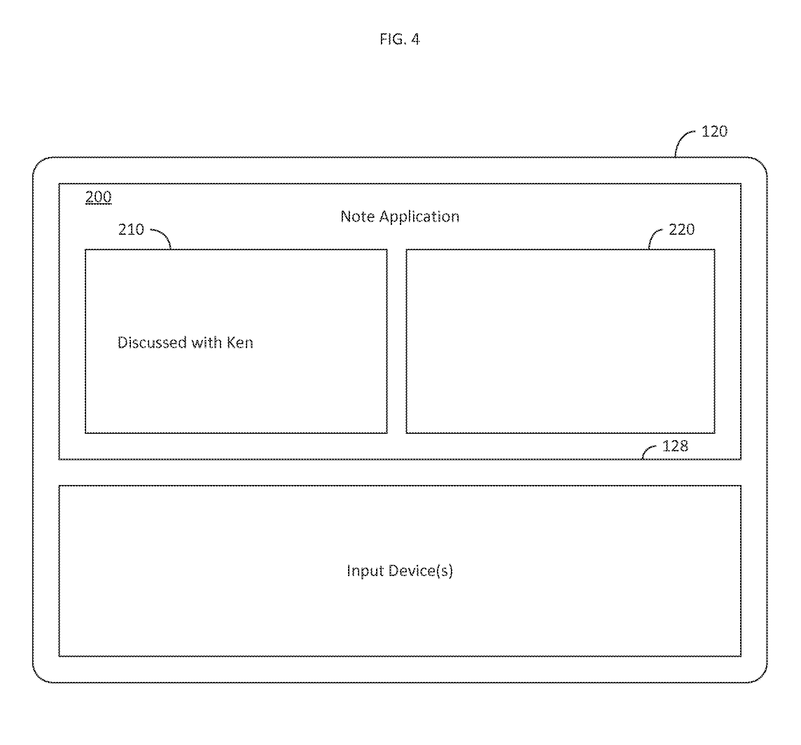

FIG. 3 is a flow diagram illustrating an exemplary method 300 of operating a CRM system 100, in accordance with an embodiment. The method begins when the note taking application 200 receives input from a user. (Step 305). As discussed above, the input may be to any data field 210 in any note taking application 200 capable of connecting to one of the database systems 110. FIG. 4 illustrates an exemplary note taking application 200 running on a computer implemented device 120, in accordance with an embodiment. As seen in FIG. 4, a user has entered the note “Discussed with Ken” into the data field 210.

The note taking application then generates a request for a suggestion based upon the received user input. (Step 310). As discussed above, the suggestion request may be initiated by the user and/or automatically by the note taking application. In this example, the user has entered three words, however, the suggestion request can be based off of as little as one character (e.g., a letter, number, punctuation mark, or the like) entered by a user. The generated suggestion request includes at least the text entered by the user into the data field 210. In one embodiment, for example, additional information could be included in the suggestion request. The additional information may be used by the database system 110 to generate more accurate suggestions. In one embodiment, for example, the additional information may include the identification of the user generating the note. The database system 110, for example, can use the identification of the user generating the note to find suggestions which are already related to the user. For example, if the note entering user has an existing connection (e.g., a contract, an account, or any other association) with one or more users or businesses in the CRM data 140 including the text “Ken,” the database system 110 may prioritize those results over other entries in the CRM data 140 with the text “Ken.” In another embodiment, for example, the suggestion request may include the current location of the user generating the note. The location could be based off of GPS data or other location data available to the computer implemented device 120. The database system 110 may prioritize entries in the CRM data 140 based upon the location of the user. For example, if the user's location is proximate to a location of a business or other user in the CRM data 140, the database system can prioritize the proximate entries over other possible entries in the CRM data. The additional information could also include the user's schedule. For example, if the user has a meeting scheduled around a certain day or time, suggestions related to that meeting are likely to be targets of the user around that date and time. As discussed in further detail below, a note could be started based upon a reference object. In these instances, for example, all of the fields in the reference object (contact names, account name, etc.) may be sent with the suggestion request such that data related to the object could be returned as suggestions.

After the suggestion request is generated, the computer implemented device 120 transmits the generated request to a database system 110. (Step 315). As discussed above, the computer implemented device 120 may utilize any type of communication system, or any combination of communication system to communicate with the database system 110.

The database system, upon receiving a request, generates one or more suggestions based upon the data included in the received request. (Step 320). In one embodiment, for example, the database system 110 may utilize one or more search algorithms to search through the CRM data 140 in order to generate the suggestion(s). In one embodiment, for example, a most recently used list may be searched first. However, any searching algorithm using any search optimization techniques may be used. The search results preferably include at least one data entry in the CRM data 140 which matches or is similar to the text entered by the user in the data field 210. Similar matches, for example, may take into account spelling errors or typographical errors entered by the user. As discussed above, the data entry in the CRM data 140 may correspond to a name (e.g., a person, a company name, a product name, or the like), an address, a telephone number, an email address, a job title, business information or any other possible information contained in the CRM data 140.

In one embodiment, for example, the database system 110 may then prioritize (i.e., order) the results based upon which results are most likely to correspond to the data entry in the CRM data 140 the user has entered or partially entered in the data field 210. The database system 110 can prioritize the results in a variety of ways. In one embodiment, for example, the database system 110 may prioritize the search results based upon an identification of the user. In this embodiment, the database system 110 may order the search results based upon how frequently the user enters notes about a particular person, business or other entity. The database system 110 could also order the results based upon one or more recent entries by the user. The database system could also prioritize the search results based upon a location of the user. In practice, a user may want to enter notes about a meeting the user is about to participate in, is currently participating in, or which was recently concluded. Accordingly, if a user is at or near a location corresponding to an entity in the CRM data 140, the text entered by the user is more likely to correspond with that nearby entity than with other entities further away. The database system 110 could also order the search results based upon other links already existing in the note. For example, if the user has already linked the note to a particular person, the database system 110 could prioritize related entries in the CRM data 140 in the suggestions. Other related entries could include, for example, a business associated with the person, another person associated with the person (e.g., another person at the same business, another person at a different business but which has connections to the first person, or the like), a telephone number, an email address, a title, a physical or mailing address, or the like. The results could also be ordered by the most recently used list, date of the data, and/or the proximity to the related object; i.e., objects closest to the note are presumed to have higher relevancy.

While the database system 110 could order the search results using any one or any combination of the methods discussed above, the database system 110 could also order the results alphabetically or by date (e.g., most recently modified), files or records that are shared with groups that a user belongs to, or objects suggested by similar users, or objects suggested by viewers of similar file, or the like.

The database system 110 then transmits the suggestion(s) to the computer implemented device 120. (Step 325). As discussed above, the database system 110 may utilize any type of communication system, or any combination of communication system to communicate with the computer implemented device 120. In one embodiment, for example, in order to improve performance on, for example, mobile devices and/or prevent repetitive network calls, the suggestions as well as related data may be cached on the computer-implemented device 120. In one embodiment, for example, some data may be cached upon startup of the note-taking application. For example, on startup of the note-taking application, the note taking application can download records related to a most recently used list or other most used objects.

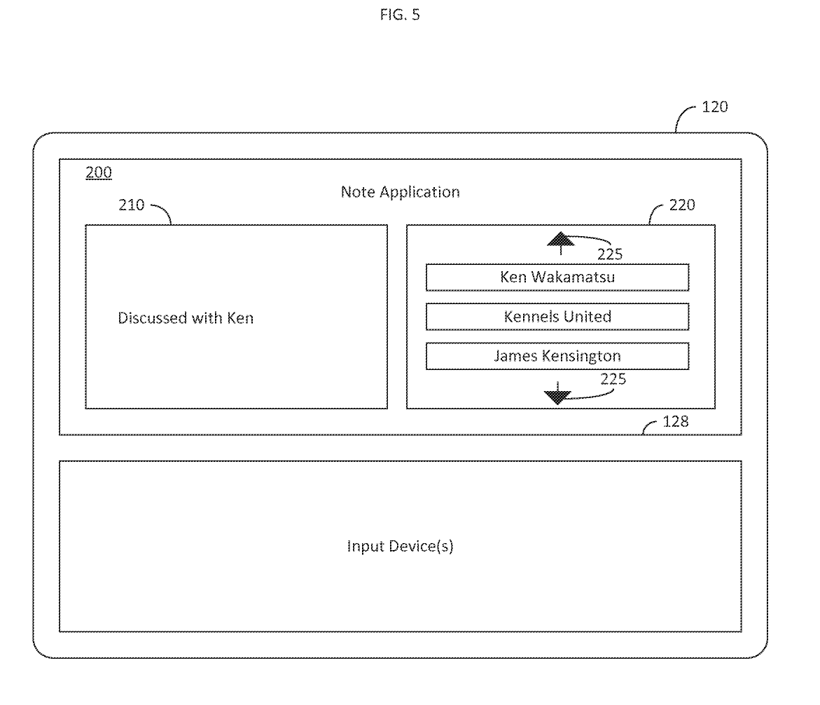

The computer implemented device 120 then displays the suggestion(s) on a display of the computer implemented device 120. (Step 330). FIG. 5 illustrates another exemplary note taking application 200 running on a computer implemented device 120, in accordance with an embodiment. As seen in FIG. 5, multiple suggestions are displayed in the suggestion/link field 220 which could correspond to the text “Ken.” In the illustrated example, the suggestions include a name “Ken Wakamatsu,” a business “Kennels United,” and another name “James Kensington.” As discussed above, the order of the suggestions can be based upon one or more of the prioritization factors discussed above. In one embodiment, for example, the suggestion/link field 220 includes interfaces 225 which allow the user to view other suggestions, when available, if the entry the user is attempting to write is not being shown. While the interfaces 225 illustrated in FIG. 5 are arrows, the interfaces could also be a page list, a next button, or any combination thereof. Furthermore, in another embodiment, for example, the interface 225 may include a reordering interface, allowing the user to select a different order of suggestions to be displayed. For example, the interface 225 may allow the user to reorder the suggestion list according to any of the ordering methods discussed herein. In embodiments where the computer implemented device 120 includes a touch screen, the interfaces 225 could be omitted and the user may be able to view more suggestion results merely by swiping on the touchscreen.

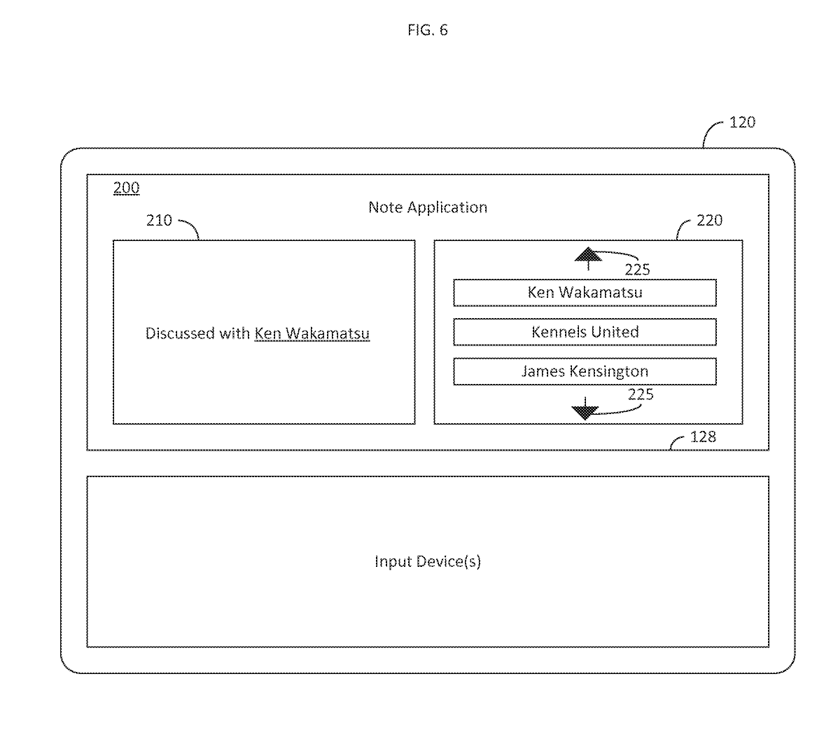

The user then has the option to select one of the suggestions displayed in the suggestion/link field 220 to link the data entry to the respective entry in the CRM data 140. (Step 335). Upon receiving the selection, the note taking application may complete the data entry. For example, if the user selects “Ken Wakamatsu” from the suggestion/link field 220, the note taking application may change the text from “Discussed with Ken,” as illustrated in FIG. 5 to “Discussed with Ken Wakamatsu,” as illustrated in FIG. 6. The note taking application may also indicate that the note is linked to the data entry in the CRM data 140. In the embodiment illustrated in FIG. 6, the linked data, “Ken Wakamatsu,” is underlined to indicate that the note is linked with the entry for Ken Wakamatsu in the CRM data 140. However, other methods for indicating the link may include, but are not limited to, highlighting, changes in font type or size, use of bolding, italics, or any combination thereof.

In one embodiment, for example, the note taking application 200 also generates an update request (Step 340) and transmits the update request to the database system 110 (Step 345) upon receipt of a selection from the suggestion/link field 220. The update request, for example, could include a request to update the CRM data 140 to include information from the note. In one embodiment, for example, the information from the note may be extracted after the user completes the note. Indications that the note is complete may include, but are not limited to, the user closing the note application, the user closing the note itself within the application, an indication to save the note via a command from the user, an expiration of a timer, or any combination thereof. For example, if the user later enters a phone number, email address or the like into the data field 210, the CRM data 140 stored in the database system 110 or the remote memory 130 can be updated to reflect the new information. In another embodiment, for example, the linking request may update a log associated with the user stored in the CRM data 140. The log, for example, could track a user's sales calls, meeting or the like. The database system 110, upon receiving the update request, updates the CRM data 140 saved in the database system 110 and/or in the remote memory 130 to reflect the information entered by the user in the data field. (Step 350).

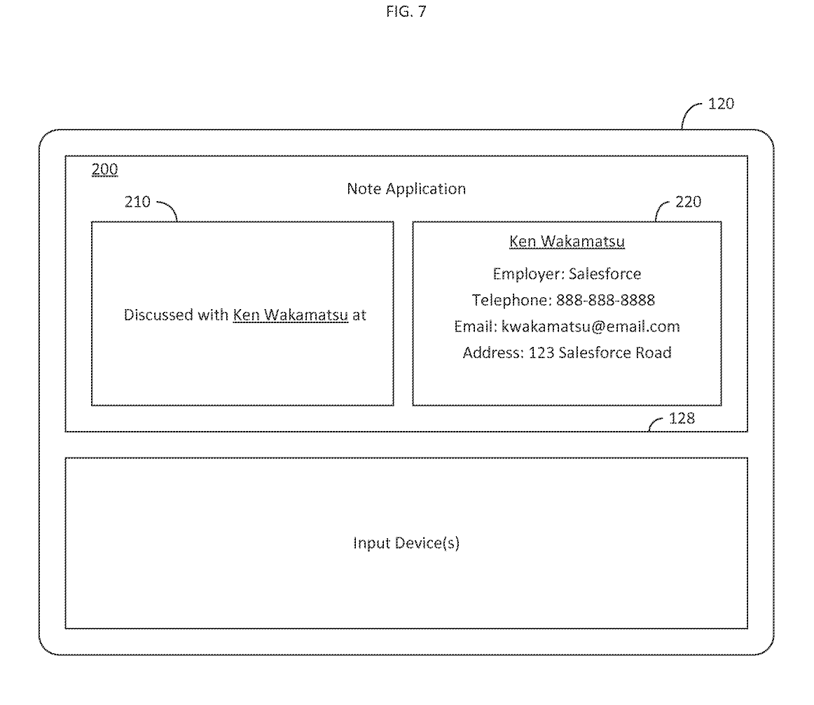

In one embodiment, for example, when a user interacts with a linked entry in the data field 210 which has been linked to the CRM data 140 in Step 335, the computer implemented device 120 may create a request for CRM data 140 related to the entry. (Step 355). The user may interact with the linked entry in the data field 210 by clicking on the linked entry, hovering over the linked entry, a verbal command, or the like. In the example illustrated in FIG. 6, if a user were to interface with the text “Ken Wakamatsu,” the computer implemented device 120 may create a request for CRM data 140 related to Ken Wakamatsu. The request is then transmitted to the database system 110 (Step 360), which in turn retrieves the requested information and transmits the requested information back to the computer implemented system 120. (Step 365). In another embodiment, for example, the database system 110 may transmit the CRM data 140 related to each suggested entry along with the suggestions in Step 325. In this embodiment, the CRM data 140 related to each entry in the suggestions can be stored in the memory 124 of the computer implemented device 120 until the user interacts with the linked data in the data field 210. The computer-implemented device then displays the related CRM data 140 in the suggestion/link field 220. (Step 370). FIG. 7 illustrates an example where the user has interacted with the linked entry “Ken Wakamatsu.” As seen in FIG. 7, information about the linked data entry is viewable in the suggestion/link field 220. The user can then interact with any of the data in the in the suggestion/link field 220 to add the data to the note. This allows a user to quickly enter a comprehensive note. While the example in FIG. 7 merely shows contact information about the linked entry, the CRM data 140 related to an entry could also, or alternatively, include open opportunities, open cases, products, contracts, orders, or the like.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method for linking data by a database system, comprising:
receiving, by the database system, data entered in a data field in an application on a computer-implemented system;
comparing, by the database system, the data entered in the data field with data entries stored in the database system;
creating, by the database system, at least one suggestion for linking the data entered in the data field with one of the data entries stored in the database system based upon the comparison;
transmitting, by the database system, the at least one suggestion to the computer-implemented system; and
linking, by the database system, the data entered in the data field with a respective data entry associated with one of the at least one suggestions when the processor receives confirmation of an association of the data entered with the suggestion.

2. The method according to claim 1, wherein the linking further comprises:
adding the data entered in the data field to the associated data entry in the database system.

3. The method according to claim 1, wherein the linking further comprises:
updating a log associated with a user of the computer-implemented system based upon the data entered in the data field.

4. The method according to claim 1, further comprising:
receiving, by the database system, a request for information related to the associated data entry from the computer-implemented system; and
transmitting, by the database system the information related to the associated data entry to the computer-implemented system.

5. The method according to claim 1, wherein the creating further comprises, ordering, by the database system, the at least one suggestion based upon an identification of the user associated with the computer-implemented system.

6. The method according to claim 1, wherein the creating further comprises, ordering, by the database system, the at least one suggestion based upon a popularity of each data entry associated with the at least one suggestion.

7. The method according to claim 1, wherein the creating further comprises, ordering, by the database system, the at least one suggestion based upon which data entry associated with each suggestion was most recently updated.

8. A mobile device, comprising:
a display;
a memory configured to store computer-readable instructions for executing a note taking application; and
a processor communicatively coupled to the display and the memory, the processor further configured to:
receive, from the note taking application, at least one character from a data field in the note taking application;
transmit to a database system the at least one character;
receive, from the database system, at least one suggestion for a data entry in the database system which matches the at least one character;
displaying, on the display, the at least one suggestion;
receiving a selected suggestion from one of the at least one suggestions; and
linking the at least one character with the data entry associated with the selected suggestion.

9. The mobile device of claim 8, wherein the linking further comprises completing, when the at least one character only partially matches the data entry associated with the selected suggestion, the at least one character to match the data entry associated with the selected suggestion.

10. The mobile device of claim 9, wherein the linking further comprises, displaying, on the display by the processor, a graphical indication indicating that the at least one character is linked with the data entry associated with the selected suggestion.

11. The mobile device of claim 10, wherein the processor is further configured to:
receive a selection of the graphical indication; and
display information related to the data entry.

12. The mobile device of claim 11, wherein the processor is further configured to transmit, when the information related to the data entry is not stored in the memory, a request for the information related to the data entry to the database system.

13. The mobile device of claim 11, wherein the processor is further configured to add to the data field information related to the data entry when the processor receives a selection from the display of information related to the data entry.

14. The mobile device of claim 8, wherein the processor is further configured to transmit to the database system the at least one character when the processor receives suggestion request indication from a user of the mobile device.

15. The mobile device of claim 8, further comprising an input device, wherein the indication is data from the input device of user input proximate to the at least one character.

16. The mobile device of claim 8, wherein the processor is further configured to automatically transmit to the database system the at least one character upon receipt of the at least one character.

17. The mobile device of claim 8, wherein the processor is further configured to transmit an update request to update the data entry associated with the selected suggestion to the database system, the update request including all of the data from the data field in the note taking application.

18. A database system, comprising:
a memory configured to store customer relationship management data and further configured to store computer-readable instructions for executing a recommendation engine; and
a processor communicatively coupled to the memory, the processor further configured to:
receiving data entered in a data field in an application on a computer-implemented system;
creating, utilizing the recommendation engine, at least one suggestion for linking the data entered in the data field with one or more data entries within the customer relationship management data stored in the memory;
transmitting, by the database system, the at least one suggestion to the computer-implemented system; and
linking, by the database system, the data entered in the data field with a respective data entry associated with one of the at least one suggestions when the processor receives confirmation of an association of the data entered with the suggestion.

19. The database system of claim 18, wherein the linking further comprises:
adding the data entered in the data field to the associated data entry in the customer relationship management data stored in the memory.

20. The database system of claim 18, wherein the linking further comprises:
updating a log stored in the memory associated with a user of the computer-implemented system based upon the data entered in the data field.
